(19) United States
(12) Patent Application Publication
(10) Pub. No.: US 2008/0132420 A1
(43) Pub. Date: Jun. 5, 2008

(54) CONSOLIDATED APPROACH TO ANALYZING DATA FROM PROTEIN MICROARRAYS

(76) Inventor: Mariusz Lubomirski, Buckingham, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/856,979

(22) Filed: Sep. 18, 2007

Related U.S. Application Data
(60) Provisional application No. 60/845,376, filed on Sep. 18, 2006.

(51) Int. Cl. C40B 30/02

(52) U.S. Cl. 506/8

(57) ABSTRACT

A data analysis system and/or method that can be used to explore the similarities and differences between two or more multi-dimensional data sets from protein microarrays is disclosed.

### CROSS REFERENCE TO RELATED APPLICATIONS

This application claims priority to Application No. 60/845,376 filed on Sep. 18, 2006, the entire contents of which are incorporated by reference herein.

### FIELD OF THE INVENTION

The present invention relates generally to protein microarrays. More particularly, the present invention relates to the analysis of high throughput protein microarray data.

### BACKGROUND

The use of DNA microarrays in biological and pharmaceutical research is well established as a means to obtain information about biological activity as an aid in drug development. The use of protein microarrays, which is emerging as a follow up technology, will also begin to experience growth as the challenges in protein to spot methodologies are overcome. Like DNA microarrays, protein microarrays produce large amounts of data that must be suitably analyzed in order to yield meaningful information that should eventually lead to the identification of novel drug targets and biomarkers.

Sundaresh et al., Bioinformatics, 22(14) (2006), discloses a technique that an analysis that performs t-tests using a Bayesian estimation of variance to identify significant bindings between antibodies and antigens in protein microarrays.

U.S. Pat. No. 7,043,500 discloses a data analysis method wherein subtractive clustering is used to explore the similarities and differences between two or more multi-dimensional data sets, e.g., a protein microarray.

U.S. Application Serial No. 20060047616 discloses a method for analyzing biological data that includes classifying a first set of biological data in a first classifier, classifying a second set of biological data in a second classifier, combining the results of the first classifier with the results of the second classifier, and analyzing the results as a function of the similarity measure of the first classifier and the similarity measure of the second classifier. The application discloses that one of the sets of biological data can be microarray data.

U.S. Application Serial No. 20050149268 discloses methods of analyzing data using ranks comprise ranking a set of captured data, comparing the ranked set of captured data to another set of ranked data, determining the change in rank between the sets, and defining the change in rank by statistical analyst.

Although the statistical management of DNA microarray data has been well described, a successful consolidated approach to the analysis of protein microarray data has not been identified. The present invention provides a methodology to analyze data from protein microarray data.

Protein microarray technology is opening a new frontier in the profiling of protein expression. With this rapidly evolving technology, the expression patterns of thousands of proteins can be monitored in high throughput with the objective of selecting a small subset of proteins that are most relevant to the situation under study. The proteins in the subset could be characterized further as potential biomarkers and/or drug targets. As such, it is expected that this technology will create a fascinating new horizon in diagnostic, prognostic and disease progression monitoring. In addition, it allows researchers to study protein functions at various levels, to determine small molecule characterization in terms of efficacy, safety and selectivity, and antibody and immune system profiling. Since the successful demonstration of the first proteome microarray based on yeast (Zhu et al., 2001), many difficulties related to arraying proteins have been recognized (Kusnezow et al., 2002). Many of the difficulties in production, isolation and spotting were addressed through the use of bacterial and yeast expression vectors, mass spectrometry techniques and contact printing (reviewed by Bertone et al., 2005). There has been a rapid evolution in application of these developments to human proteins resulting in arrays, which are used both alone and in conjunction with other discovery techniques to develop biomarkers and novel drug targets from scientists and developers who are in quest of new drug treatments. (Ilyin et al., 2004; Lou et al., 2006).

As with DNA microarrays, the large amount of data generated by protein microarrays requires careful handling and appropriate analysis. Although the result of a data analysis is largely dependent on the quality of the data available, the analysis itself is instrumental in correctly directing scientists in their research. Incorrect conclusions can extend the duration of projects, and frustrate and further swell already stretched budgets. Every effort must be made to employ the best knowledge and experience to appropriately analyze and deliver correct conclusions. Although studies involving protein microarrays are new for expressional experimentation, the use of DNA microarrays is now reaching maturity with respect to hardware advances and statistical methodologies employed. Publications, studies and seminars on the subject can be applied to data generated by protein microarrays. The present invention provides a comprehensive set of methods to apply to accurately analyze protein microarray data. The present invention employs successful adaptation of several DNA microarray statistical methodologies to protein microarray technology to select a small subset of possible protein targets, which can then become the subject of further assay validation.

### SUMMARY OF THE INVENTION

Accordingly, it is an object of the invention to provide a convenient and accurate method to analyze protein microarray data.

In accordance with one aspect of the invention, there are provided methods of analyzing data comprising:

(a) preprocessing protein microarray data;

(b) verifying that differences among distinct groups of proteins in the protein microarray data is observable in the protein microarray data;

(c) identifying distinct groups of proteins and features associated with the distinct groups; and

(d) corroborating the features identified.

The present methods are advantageous in providing a convenient and accurate method for analyzing protein microarray data.

Other aspects, features and advantages of the invention will be apparent from the following disclosure, including the detailed description of the invention and its preferred embodiments and the appended claims.

### BRIEF DESCRIPTION OF THE FIGURES

FIG. 1, is a schematic showing the application of serum sample to the surface of a protein microarray with fixed proteins. After the sample is applied to the protein microarray, a fluorescent marker is added; the array is washed and dried; and the array is scanned to determine the presence or absence of the proteins in the sample.

FIGS. 2A and 2B are scatterplots (FIG. 2A) and boxplots (FIG. 2B) of the data before transformation.

FIGS. 3A and 3B are scatterplots (FIG. 3A) and boxplots (FIG. 3B) of the data after transformation.

FIG. 4, illustrates mean versus standard deviation of normalized and log transformed samples. Lowess smoothing line remains largely horizontal indicating low correlation. Lowess is a data analysis technique for producing a “smooth” set of values from a scatterplot with a “noisy” relationship between two variables. The full name of LOWESS is “robust locally weighted regression and smoothing scatterplots”. It is a commonly used algorithm for drawing a smooth curve through a number of points. LOWESS works by assuming a small segment of any curve can be approximated by a straight line. For each data point, LOWESS finds the n nearest points to that data point (n is configurable), and performs weighted linear regression using a tricube weighting function. It then adjust the coordinates of the data point based on the result of the weighted linear regression. LOWESS can run in multiple iterations, in which case it should converge to a stable curve—thus it is called “robust”.

FIG. 5, is a boxplot showing negative control raw values of 20 samples in the experiment. The outlier sample, S9, is clearly visible.

FIG. 6, is a spectral map of the protein array data, wherein squares are a sort of principal component display of the samples and circles are a sort of principal component display of the proteins. Normal (blue), Disease1 (green), Disease2 (magenta), Proteins (orange). Proteins shown in red correspond to the most distal proteins. The separation of the diseased and normal samples is evident. The normal samples are clustered around the center of the map, while the two sets of diseased samples appear at the opposite ends of the map. FIG. 6 shows that the separation of these three groups is indeed the dominant signal in the data.

FIGS. 7A and 7B illustrate protein selection to minimize out of bag (“OOB”) error rates. In random forests, there is no need for cross-validation or a separate test set to get an unbiased estimate of the test set error. It is estimated internally, during the run, as follows: Each tree is constructed using a different bootstrap sample from the original data. About one-third of the cases are left out of the bootstrap sample and not used in the construction of the k^{th} tree. Each case left out in the construction of the k^{th} tree is put down the k^{th} tree to get a classification. In this way, a test set classification is obtained for each case in about one-third of the trees. At the end of the run, j is taken to be the class that got most of the votes every time case n was oob. The proportion of times that j is not equal to the true class of n averaged over all cases is the oob error estimate. This has proven to be unbiased in many tests. The procedure calculates OOB error rates for a consecutively shrinking set of proteins. The set of proteins corresponding to the lowest OOB is the optimum set. FIG. 7A. Error rates with total number of proteins. FIG. 7B. Error rates with reduced set of proteins.

### DETAILED DESCRIPTION

All publications cited herein are hereby incorporated by reference. Unless defined otherwise, all technical and scientific terms used herein have the same meaning as commonly understood to one of ordinary skill in the art to which this invention pertains. As used herein, the terms “comprising”, “containing”, “having” and “including” are used in their open, non-limiting sense.

### Definitions

“An activity”, “a biological activity”, or “a functional activity” of a biological molecule, for example, a peptide, a polypeptide, protein or nucleic acid refers to an activity exerted by the peptide, polypeptide, protein or nucleic acid molecule as determined in vivo, or in vitro, according to standard techniques. Such activities can be a direct activity, such as an association with or an enzymatic activity on a different protein or a metal ion-enzyme complex, or an indirect activity, such as a cellular signaling activity mediated by interaction of the peptide, polypeptide or protein with one or more than one additional peptide, polypeptide or protein or other molecule(s), including but not limited to, interactions that occur in a multi-step, serial fashion.

A “biological sample” or “sample” as used herein refers to a sample containing or consisting of cell or tissue matter, such as cells, cell associated body fluids, biological fluids, culture supernatants or peptide, polypeptide or protein isolated from a subject or patient. The “subject” can be bacteria, yeast, arthropods, a mammal, such as a rat, a mouse, a dog, a monkey, a human, or any other organism, that has been the object of treatment, observation or experiment. Examples of biological samples include, for example, sputum, blood, blood cells (e.g., white blood cells), amniotic fluid, plasma, semen, bone marrow, tissue or fine-needle biopsy samples, hair, nails, urine, peritoneal fluid, pleural fluid, and cell cultures. Biological samples can also include sections of tissues such as frozen sections taken for histological purposes.

A “test biological sample”, “test sample”, “patient sample” or “sample” is the biological sample that has been the object of analysis, monitoring, or observation. A “control biological sample”, “control sample” or “control” can be either a positive or a negative control for the test biological sample. Often, the control sample contains the same type of tissues, cells and/or biological fluids of interest as that of the test sample.

A “cell” refers to at least one cell or a plurality of cells appropriate for the sensitivity of the detection method. Cells suitable for the present invention can be bacterial, other prokaryotes or eukaryotes.

Examples of “cell-associated body fluids” include blood fluids (e.g. whole blood, blood serum, blood having platelets removed there from, etc.), lymph, ascitic fluids, gynecological fluids (e.g. ovarian, fallopian, and uterine secretions, menses, vaginal douching fluids, fluids used to rinse cervical cell samples, etc.), cystic fluid, urine, saliva and fluids collected by peritoneal rinsing (e.g. fluids applied and collected during laparoscopy or fluids instilled into and withdrawn from the peritoneal cavity of a human patient). The fluid can, of course, be subjected to a variety of well-known post-collection preparative and storage techniques (e.g. storage, freezing, ultrafiltration, concentration, evaporation, centrifugation, etc.) prior to assessing the amount of the marker in the fluid.

A “polypeptide sequence” or “protein sequence” refers to the arrangement of amino acid residues in a polymer. Polypeptide sequences can be composed of the standard 20 naturally occurring amino acids, in addition to rare amino acids and synthetic amino acid analogs. Shorter polypeptides are generally referred to as peptides.

An “isolated” or “purified” protein or biologically active portion thereof is substantially free of cellular material or other contaminating proteins from the cell or tissue source from which the protein is derived, or substantially free of chemical precursors or other chemicals when chemically synthesized. The language “substantially free of cellular material” includes preparations of protein in which the protein is separated from cellular components of the cells from which the protein is isolated or recombinantly produced. Thus, protein that is substantially free of cellular material includes preparations of protein having less than about 30%, 20%, 10%, or 5% (by dry weight) of heterologous protein (also referred to herein as a “contaminating protein”). When the protein or biologically active portion thereof is recombinantly produced, the protein is also preferably substantially free of culture medium, i.e., culture medium represents less than about 20%, 10%, or 5% of the volume of the protein preparation. When the protein is produced by chemical synthesis, the protein is preferably substantially free of chemical precursors or other chemicals, i.e., the protein is separated from chemical precursors or other chemicals that are involved in the synthesis of the protein. Accordingly such preparations of the protein have less than about 30%, 20%, 10%, 5% (by dry weight) of chemical precursors or compounds other than the polypeptide of interest. Isolated biologically active polypeptide can have several different physical forms. An isolated polypeptide can exist as a full-length nascent or unprocessed polypeptide, or as a partially processed polypeptide or as a combination of processed polypeptides. The full-length nascent polypeptide can be postranslationally modified by specific proteolytic cleavage events that result in the formation of fragments of the full-length nascent polypeptide. The full-length protein or fragments of the polypeptide can be chemically modified. A fragment, or physical association of fragments can have the biological activity associated with the full-length polypeptide; however, the degree of biological activity associated with individual fragments can vary. An isolated or substantially purified polypeptide, can be a polypeptide encoded by an isolated nucleic acid sequence, as well as a polypeptide synthesized by, for example, chemical synthetic methods, and a polypeptide separated from biological materials, and then purified, using conventional protein analytical or preparatory procedures, to an extent that permits the polypeptide to be used according to the methods described herein.

The term “expression” as used herein refers to a multi-step process that includes transcription and translation of a gene and is often followed by folding, post-translational modification and targeting of the resulting protein. The amount of protein that a cell expresses depends on the tissue, the developmental stage of the organism and the metabolic or physiologic state of the cell.

“Sequence” means the linear order in which monomers occur in a polymer, for example, the order of amino acids in a polypeptide.

The “normal” level of expression of a peptide, polypeptide or protein, is the level of expression of the peptide, polypeptide or protein in cells of a patient, e.g. a human, or a sample, not afflicted with disease.

“Over-expression” and “under-expression” of a peptide, polypeptide or protein, refer to expression of the peptide, polypeptide or protein of a patient or a sample at a greater or lesser level, respectively, than normal level of expression of the peptide, polypeptide or protein (for example at least 1.25 fold greater or 0.5 fold lower).

Expression of a peptide, polypeptide or protein in a patient or sample is “significantly” higher or lower than the normal level of expression of a peptide, polypeptide or protein if the level of expression of the peptide, polypeptide or protein is greater or less, respectively, than the normal level by an amount greater than the standard error of the assay employed to assess expression, and preferably at least 1.25, 1.5, 1.75 and more preferably two, three, four, five or ten times that amount. Alternately, expression of the peptide, polypeptide or protein in the patient can be considered “significantly” higher or lower than the normal level of expression if the level of expression is at least about 1.25, 1.5, 1.75, two, and preferably at least about three, four, or five times, higher or lower, respectively, than the normal level of expression of the peptide, polypeptide or protein.

The present invention relates to methods involving the analysis of protein microarray data.

In practicing the present invention, many conventional techniques in molecular biology, microbiology and recombinant DNA are used. These techniques are well-known and are explained in, for example, Current Protocols in Molecular Biology, Vols. I, II, and III, F. M. Ausubel, ed. (1997); and Sambrook et al., Molecular Cloning: A Laboratory Manual, Cold Spring Harbor Laboratory Press, Cold Spring Harbor, N.Y. (2001).

The present invention can be employed to identify peptides, polypeptides and proteins which can be used, e.g., to 1) assess whether a patient is afflicted with a disease or pathology; 2) assess the stage of disease or pathology in a human patient; 3) monitor the progression of disease or pathology in a patient; 4) select a composition or therapy for inhibiting disease or pathology in a patient; 5) assess the efficacy of one or more test compounds for inhibiting disease or pathology in a patient; 6) assess the efficacy of a therapy for inhibiting disease or pathology in a patient; 7) treat a patient afflicted with a disease or pathology r; 8) inhibit disease or pathology in a patient; 9) assess the disease or pathology potential of a test compound; and 10) inhibit a disease or pathology in a patient at risk for developing that disease or pathology.

### EXAMPLES

### Protein Microarray

A data analysis methodology was applied to a human protein microarray experiment. The purpose of the experiment was to identify proteins that are recognized by antibodies present in human serum with the intention to identify autoantibodies. An “autoantibody” is an antibody that reacts with proteins of the individual in which it was produced. Reaction of an autoantibody with a peptide, polypeptide or protein prevents the peptide, polypeptide or protein from its activity, which may lead to autoimmune disease. The hallmarks of these autoimmune diseases are high levels of specific antibodies directed to a particular target protein (Nielen M, et al, Specific Antibodies precede the symptoms of rheumatoid arthritis, Arthritis and Rheumatism 50, pp. 380-386) Disregulation of the target protein by the antibody results in pathogenesis of the disease as shown, for example, in diabetes where antibodies to insulin and insulin producing cells are formed, the ability to adequately monitor glucose levels are inhibited, and disease results (Itoh 1989). Measuring the levels of autoantibodies to insulin or insulin producing islet cells could be predictive of the onset of diabetes in children (Pietropaolo 2005). Recently this type of serum biomarker has been extended to diseases not classically defined as autoimmune diseases. Detection of disease-related antibodies and autoantibodies may be used as biomarkers to predict disease and/or observe disease progression. Circulating IL-8 and anti-IL-8 antibody have been shown to be elevated in the sera of patients with ovarian cancer as compared with healthy controls and have therefore been proposed as potential biomarkers for ovarian cancer (Lokshin 2006). In addition, the presence of specific antibodies in the blood may be used as predictors of inflammatory bowel disease (Israeli 2005). Two of the most common antibodies found in the sera of patients with Crohn's disease and Ulcerative Colitis are anti-Saccharomyces cerevisiae mannan antibodies (ASCA) in Crohn's disease and perinuclear antineutrophil cytoplasm antibodies (pANCA) in ulcerative colitis. It is hoped that the detection of ASCA and pANCA will serve to predict the development of inflammatory bowel disease years in advance of clinical diagnosis of the disease (Israeli 2005). Interestingly, it was hypothesized that even Alzheimer's disease may be a form of an autoimmune disease, as the presence of Ig-positive neurons in brain tissues has been reported (D'Andrea, 2003; 2005a; 2005b).

In this experiment, one set of five normal serums and two sets of diseased serums, corresponding to two autoimmune diseases, are examined to give a total of twenty serum samples. Using commercially available protein microarrays (Invitrogen), serum antibodies from the normal and diseased patients were applied to interact with fixed proteins on the array. Because the identity of each protein on the array is known, the autoantibodies present in the disease serum can be identified based on the proteins with which they interact. A goal is to find autoantibodies that would form the basis for diagnostic, prognostic and disease progression biomarkers for the two human disease states. These potential biomarkers may be used separately to distinguish diseased from normal individuals or in a panel of several biomarkers to strengthen the decision making process.

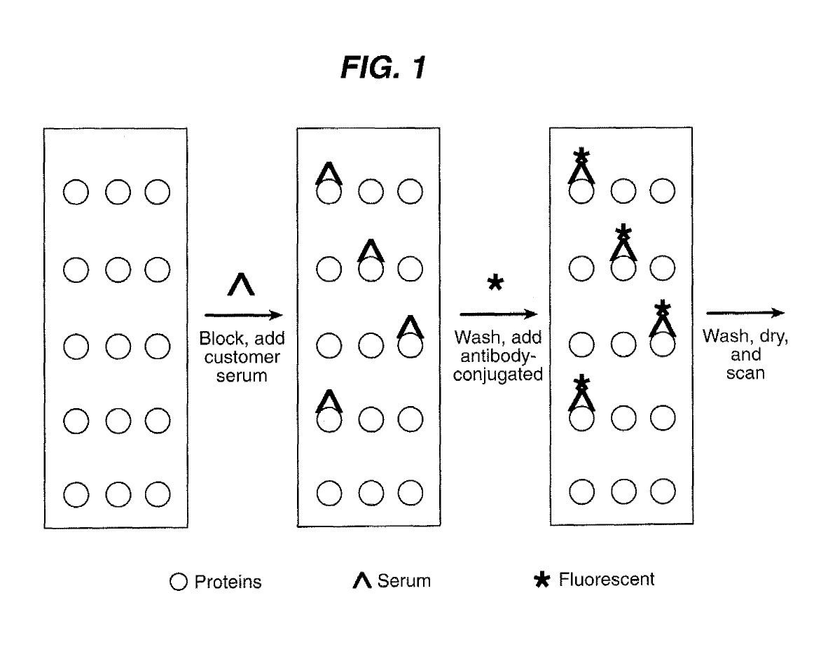

The protein microarray used in this experiment contains double spotted human proteins with distinct subarrays with a number of assay specific positive controls and a set of negative controls included for quality assessment purposes. First, known proteins are mounted on nitrocellulose-coated glass slides. Then, the serum and subsequently the fluorescent-labeled antibody are added. The protein microarray is then washed, dried and scanned (as depicted in the schematic shown in FIG. 1). The measurement of the fluorescence signal is corrected by the background signal, which is measured at a radius a small distance away from the circular feature.

### Data Analysis

Separation of responders from non-responders in microarray experiments is a difficult task since microarrays are inherently noisy devices. This is further compounded by the small number of samples available for investigation, which is usually the case in most early research and development situations. A consolidated approach that for DNA microarrays, has performed well in selecting genes with high validation rates (Amaratunga et al., 2003) has been implemented for protein array analysis. The analysis involves pulling all the arrays together using normalization and variance stabilizing transformation in order to enable the application of a variety of statistical tests and data mining methodologies. The complete approach includes the following four steps:
Step 1: A preprocessing step to suitably normalize, transform and quality check the data.
Step 2: A proof of concept step to verify that the purported differences among the distinct groups is indeed observable in the data.
Step 3: A feature detection step to identify distinct groups of proteins and signatures associated with the distinct groups.
Step 4: A validation step to corroborate the features identified.
   This approach is described below using the following notation: Xij denotes the spot intensity corresponding to the i^{th} protein on the j^{th} array.

### Step 1: the Preprocessing Step

The first step of preprocessing is normalization, which is used to reduce disparities between arrays caused by technical effects such as scanner and operator effects. “Normalization” is the process of removing statistical error in repeated measured data. A normalization is sometimes based on a property. In the foregoing experimental context, normalizations are used to standardize the microarray data to enable differentiation between real (biological) variations and variations due to the measurement process. To apply normalization, a mock reference array {Mi} is created by taking the median across arrays: Mi=medianj(Xij). All arrays are normalized to this reference array using quantile normalization (i.e., normalization based on the magnitude of measures), whose objective is to make the distributions of the transformed spot intensities, {Xij}, as similar as possible across the microarrays. To normalize the j^{th} array to the reference array, the values of each of the arrays are sorted and linear interpolation is used to predict the reference array value from the value on the array being normalized. “Linear interpolation” is a process wherein new data points from a discrete set of known data points are constructed by constructing a function which closely fits those data points. The function must go exactly through the data points based on the assumption that the three plotted points lie on a straight line. The quantile normalized arrays should all have a distribution identical to the distribution of the mock reference array, unless there are ties that could cause small discrepancies.

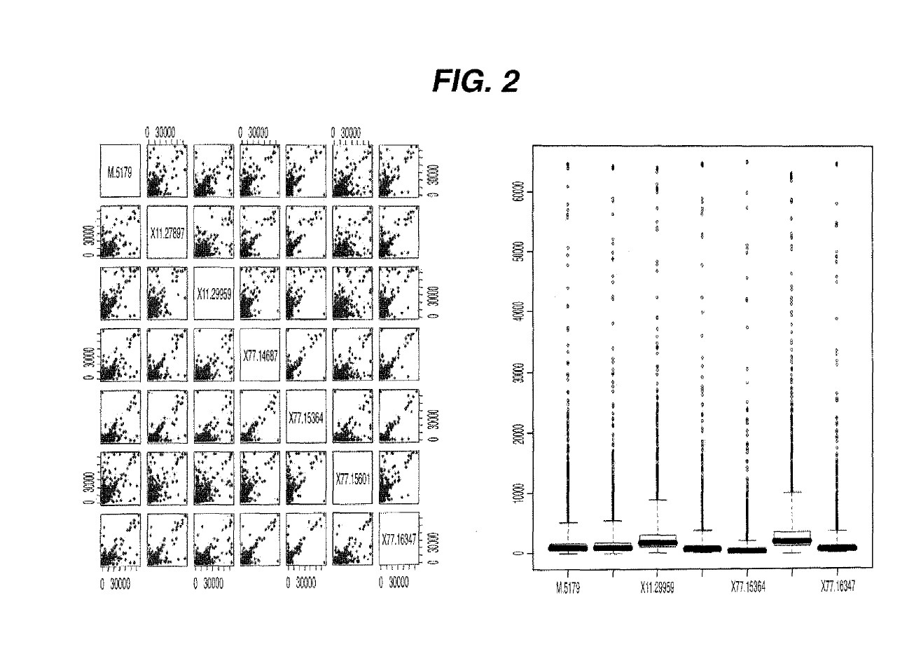

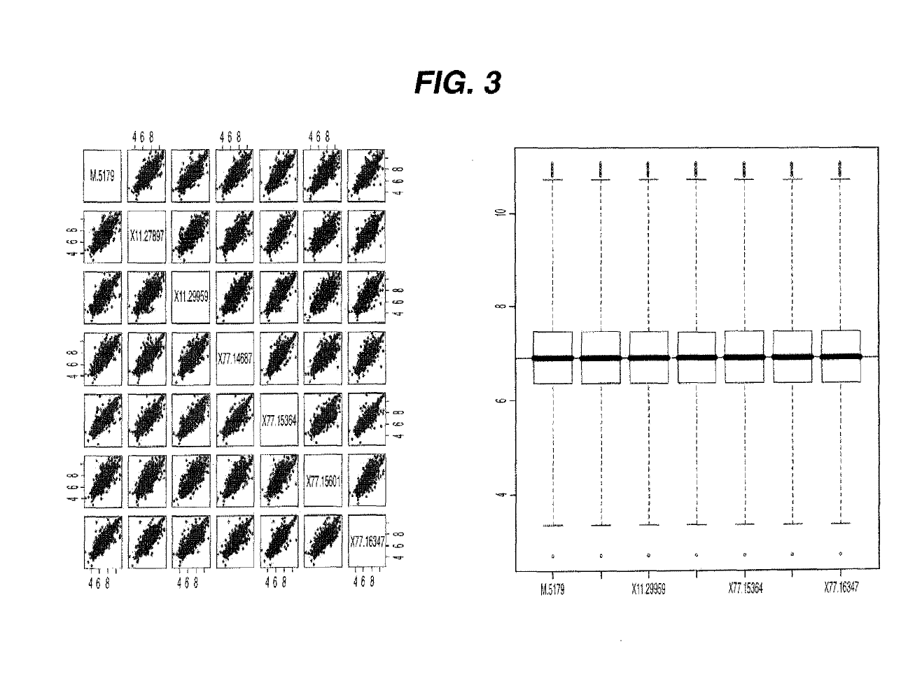

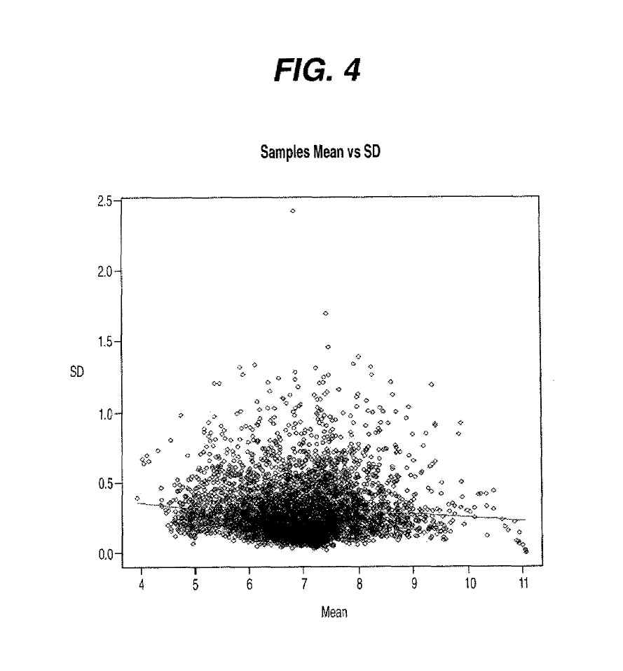

Next the data are transformed to reduce the skewness in the data and the heterogeneity of variances across proteins. Although the log transformation is the most commonly used transformation for microarray data, a variant, a started log transformation: Yij=log(Xij+c) as disclosed in Rocke et al. (2002) [Estimation of Transformation Parameters in Microarray Data, Bioinformatics 19], was employed, as it is more effective at achieving the stated objectives. The value c was chosen to optimize a criterion that is a composite of three measures: (1) the average skewness across proteins, (2) the correlation between protein mean and protein variance and (3) the coefficient of variation across proteins. Scatterplots and boxplots of the data before transformation (FIG. 2) and after transformation (FIG. 3) show considerable improvement. A “scatterplot” is a summary of a set of bivariate data (two variables) that gives a visual picture of the relationship between the two variables, and aids the interpretation of the correlation coefficient. Each unit contributes one point to the scatterplot, on which points are plotted but not joined. The resulting pattern indicates the type and strength of the relationship between the two variables. A “boxplot” is a way of summarizing a set of data measured on an interval scale. It is a type of graph which is used to show the shape of the distribution, its central value, and variability. The picture produced consists of the most extreme values in the data set (maximum and minimum values), the lower and upper quartiles, and the median. The LOG function has the defining property that LOG (X*Y)=LOG(X)+LOG(Y)—i.e., the logarithm of a product equals the sum of the logarithms. Therefore, logging tends to convert multiplicative relationships to additive relationships, and it tends to convert exponential (compound growth) trends to linear trends. By taking logarithms of variables which are multiplicatively related and/or growing exponentially over time, their behavior can be explained with linear models. A plot of protein means versus their standard deviations shows reasonably low correlation between the two (FIG. 4). Thus, the normalized and log transformed data has satisfied distributional assumptions for hypothesis testing and has enabled direct comparison of protein profiles.

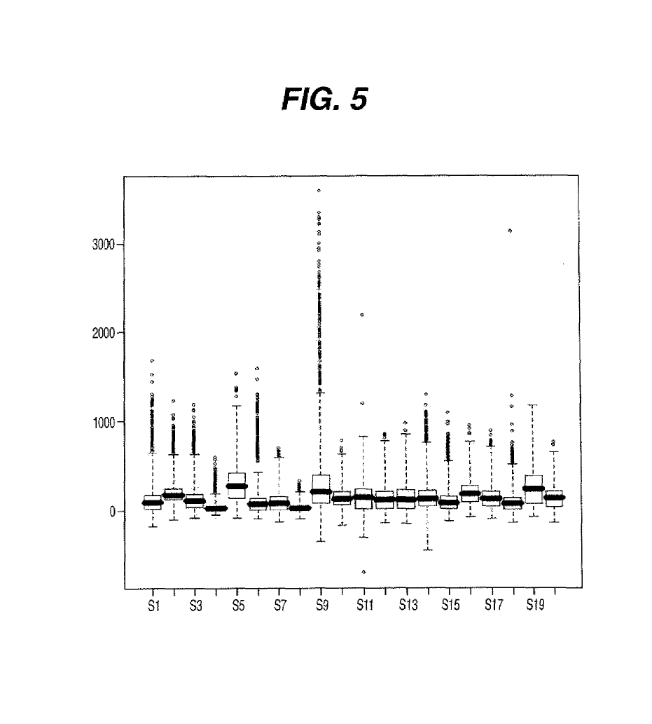

As a quality check, Spearman correlations were calculated between each pair of arrays. This in combination with a boxplot of the negative controls (FIG. 5), identified one outlier array, which was eliminated from further analysis. The remaining analyses are all carried out on this reduced normalized and transformed data matrix. Correlation summarizes the strength of the relationship between two variables. The two variables are paired observations. Spearman correlations require data that are at least ordinal and the calculations are carried out on the ranks of the data. Each variable is ranked separately by putting the values of the variable in order and numbering them: the lowest value is given rank 1, the next lowest is given rank 2, and so on. If two data values for the variables are the same they are given averaged ranks, so if they would have been ranked 14 and 15 then they both receive rank 14.5.

### Step 2: The Proof of Concept Step

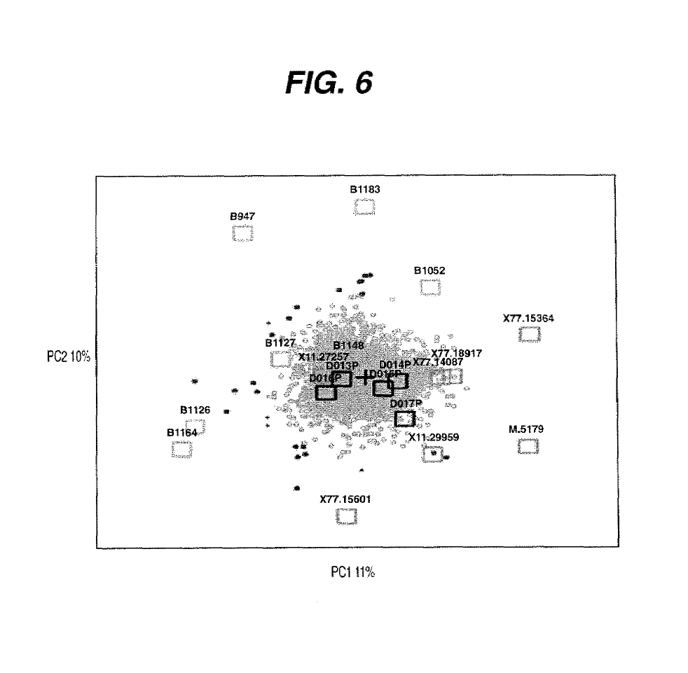

The next step is to verify that the purported differences among the groups are indeed observable in the data. This is readily done via a spectral map. A “spectral map”, a variant of Gabriel's (1971) biplot, is a graph that displays markers for both proteins and biological samples, the markers being calculated from a weighted singular value decomposition of the data matrix {Yij} as described by Lewi (1976) in a chemometrics setting and by Wouters et al (2003) for DNA microarrays. Gabriel (1971) discloses that any matrix of rank two can be displayed as a biplot which consists of a vector for each row and a vector for each column, chosen so that any element of the matrix is exactly the inner product of the vectors corresponding to its row and to its column. Lewi (1976) discloses spectral map analysis (SMA) as a means of separation of biological activity profiles into potency and spectra as a preliminary step in classifying compounds for structuring assays. Classification of the activity spectra aims at grouping of those compounds that share some (possibly unknown) mechanism of action. Given that information contained in the spectra may be scrambled by the relative potencies of the compounds due to different specific activities at a receptor site and to differing pharmacokinetic properties, the classification procedure is preceded by a step that separates the relative potencies from the activity spectra. Compounds that show no dissociation of scales X1 and X2 have their images on identity line Y1. Compounds that present comparable degrees of dissociation will be found on lines that run parallel to identity line Y1. If line Y2 is drawn perpendicularly to the identity line Y1, each of the parallel lines projects into a single point of Y2. In fact, the original X-space has been transformed into a new space defined by the orthogonal axes Y1 and Y2, containing, respectively, the potency and spectral information. Whereas each of the original X-scales contained part of the potency and part of the spectral information, these two aspects of the compounds are separated by the mappings on the new Y-scales. A projection of the identify line Y1 produces an ordering of the compounds by their relative potencies in the combined tests and is therefore called a “potency mapping.” The transformation of the original X-space into Y-space is defined by the following equation:

$$Y = X \times T and T = [ \begin{matrix}\frac{1}{\sqrt{3}} & \frac{1}{\sqrt{2}} & \frac{1}{\sqrt{6}} \\ \frac{1}{\sqrt{3}} & - \frac{1}{\sqrt{2}} & \frac{1}{\sqrt{6}} \\ \frac{1}{\sqrt{3}} & 0 & - \frac{2}{\sqrt{6}}\end{matrix} ] \qquad ( Eq . 2 )$$

where X is a matrix arrangement of logarithmical ED50's observed on n compounds in 2 assays and where Y denotes a matrix of the same size as X. The matrix Y contains the potency mapping of the n compounds in the first column and the corresponding spectral mapping in the second column. The square matrix T brings about the transformation and the columns of T correspond with the (normalized) vectorial coefficients of the axes Y1 and Y2. The square roots in the denominators are normalizing factors which ensure that the sums of the squared coefficients add up to unity. By multiplying the columns of T element-by-element, one can verify that the results add up exactly to zero, which expresses orthogonally between new axes Y1 and Y2. Each element of the product (Yij) is computed by multiplying element-by-element, the ith row of X with the jth column of T and by adding up the results. Wouters et al. (2003) discloses the use of SMA to analyze gene expression data. “SMA was originally developed for the display of activity spectra of chemical compounds (Lewi, 1976). The algorithm for spectral mapping is characterized by: constant weighting of rows and columns or weighting by some properly chosen weighting factor, logarithmic reexpression, double centering, global normalization and factor scaling using either symmetric scaling with singular values (α=0.5, β=0.5) or asymmetric scaling (α=1, β=0). A further characteristic of SMA is that in the biplot the areas of the symbols are made proportional to a selected column, or to marginal row and column totals. The double-centering transformation in SMA is symmetric with respect to the rows and columns of the data table. As a result of the double centering, all absolute aspects of the data are removed. What remains are contrasts between different rows (genes) and between different columns (samples) of the data table. These contrasts can be expressed as ratios due to the logarithmic transformation. The contrasts can be understood as specificities of the different genes for the different samples. Conversely, they refer also to the specificities or preferences of the different samples for some of the genes. Therefore, one could state that SMA provides a visualization of the interactions between genes and samples. FIG. 6 shows a spectral map of the protein array data, the circles are a sort of principal components display of the proteins, while the squares are a sort of principal components display of the samples. The separation of the diseased and normal samples is clearly evident. The normal samples are clustered around the center of the map, while the two sets of diseased samples appear at the opposite ends of the map. Thus this graph shows that the separation of these three groups is indeed the dominant signal in the data.

### Step 3: Feature Detection Step to Identify Statistically Significant Proteins

A statistical test should be carried out for each protein. The choice of test depends on the experimental design. An objective of the present experiment is to determine proteins that are significantly different between the diseases and compared to the control A Tukey's studentized range test was therefore employed (Tukey, 1951, 1953).

### Identifying Significant Protein Combinations

A protein-by-protein analysis by definition precludes identifying groups of proteins that in combination may be more predictive than any individual protein. A number of multivariate analysis approaches may be used to find such proteins. Two methods that have a proven track record in the analysis of DNA microarray data: (1) random forest and (2) spectral map analysis were employed.

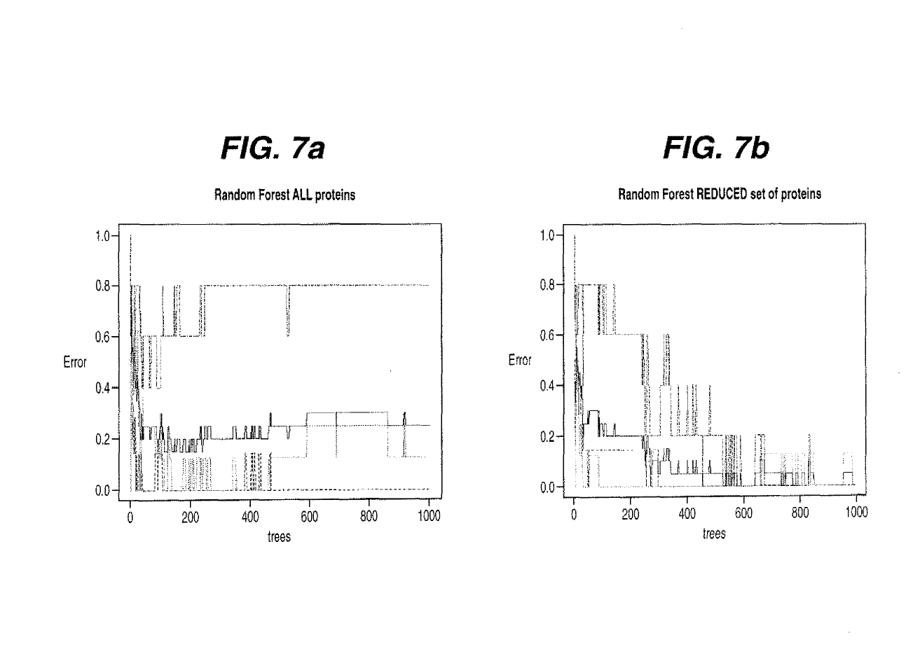

(1) Application of random forest (Breiman 2001) has been found to give consistently good performance in classification and gene importance selection in the analysis of DNA microarray data (Lee et al 2005, Diaz-Uriarte and de Andres, 2006). In random forest classification, partitioning trees are built by successively splitting the samples according to a measure of impurity at a given node until terminal nodes are as homogenous as possible. The measure of impurity is usually determined by entropy or the Gini index of diversity. The consequence of a small number of samples and a large number of expressions leads to the possibility of a non-unique solution due to many expressions leading to the same splits. Hence forests of many trees, typically in excess of 1000 are built. The 19 protein array samples were used in the supervised mode to build a classification model and the importance measure was used for protein selection. Variable selection from random forests (Diaz-Uriarte and de Andres, 2006) eliminated a large number of proteins to optimize out-of-bag (OOB) error rates, FIG. 7. In the end 49 proteins were identified, 21 of which overlap with the proteins identified by Tukey testing.

(2) Spectral Map analysis was already mentioned at the proof of concept stage described earlier. An additional advantage of a spectral map lies in its ability to elicit correlations between proteins and biological samples. Thus the proteins located at the edges of the map and away from the center are noted as being the most highly associated with disease discrimination. In our study 0.5% of most distal proteins were selected for further investigation. These proteins are shown in red, FIG. 6.

### Step 4: Validation of Features Identified

Validation studies can be carried out to analyze a larger set of samples to confirm antibody involvement observed in the initial experiment. Once the number of differentially expressed antibodies found in the analyses are reduced, a second assay system can be employed to assess the reduced number of antibodies. ELISA could be performed to determine levels of antibody to each of the specific antigens. An alternative approach would be analysis by western and immunohistochemistry. These protein analysis methods would provide feedback as to the levels and distribution of the antigen proteins and the associated specific antibody levels. The function or location of a subset of proteins could also be examined. This type of analysis would show how a group of associated proteins may be more valuable than a single protein for use as a biomarker. A systematic method to analyze protein microarray data is disclosed. The method includes a preprocessing step to suitably normalize, transform and quality check the data; a proof of concept step to verify that the purported differences among the distinct groups of proteins is observable in the data; a feature detection step to identify distinct groups of proteins and features associated with the distinct among groups; and a validation step to corroborate the features identified. Even though the statistical methodologies described here have been used to process and analyze data generated by DNA microarrays, they have not been reportedly applied to process proteomic data. These statistical methods are known to produce valuable clues in search for meaningful data that could advance to novel targets and biomarkers. Very little is known about a reliable statistical scheme to manage protein array data allowing to identify the proteins that vary in response to the particular condition under study. While other methods based around non-consolidated approaches may leave protein array data unusable or misleading, the approach using DNA array analysis techniques applied to the analysis of protein array data can yield much greater value. This multipronged approach allows analysis of protein clusters rather than single proteins. The continuous analysis paradigm utilizing random forest and spectral maps is more amenable to the discovery of a panel of protein biomarkers than alternative approaches. This is advantageous in that panels of protein biomarkers have proved to be more useful in the diagnosis of disease states than single proteins (Xiao Z et al, Proteomic Patterns: their potential for disease diagnosis., Mol Cell Endocrinol. 2005, 31.

A series of precise steps from a great variety of different possible approaches has been defined. In the preprocessing step, the use of quantization and data transformation reduced the disparities between arrays enabling application of analysis methods across all arrays simultaneously. In the second step, the spectral maps are used as an unsupervised classification tool to demonstrate existence of dominant signal for the separation of the groups. In the supervised classification step using random forest, proteins associated with the separation of groups are identified. Finally, individual protein-by-protein analysis gives further insight into differentially expressed entities.

The statistical methodologies employed reduce a large data set to a small number of proteins of interest. Small number of specific target proteins can be further validated by specific assays such as ELISA, which are more accurate and precise than the high throughput screening methods.

### Software

All analyses were performed using the R software platform which can be freely downloaded from CRAN, the Comprehensive R Archive Network with the use of the DNAMR library modules The random Forest and varSelRF are available as CRAN libraries. While the foregoing invention has been described in some detail for purposes of clarity and understanding, these particular embodiments are considered as illustrative and not restrictive. It will be appreciated by one skilled in the art from a reading of this disclosure that various changes in form and detail can be made without departing from the true scope of the invention and appended claims.

### REFERENCES

D'Andrea, Evidence that the immunoglobulin-positive neurons in Alzheimer's disease are dying by the classical complement pathway, Am J AD and Other Dementia's, 20(3): 144-150, 2005a.
D'Andrea, Add Alzheimer's disease to the list of autoimmune diseases, Medical Hypotheses, 64(3):458-463, 2005b.
D'Andrea, Evidence linking autoimmunity to neuronal cell death in Alzheimer's disease, Brain Research, 982 (1): 19-30, 2003.
Zhu H, Global Analysis of Protein activities Using Proteome Chips, Science, (293), 2001.
Amaratunga et al. Exploration and Analysis of DNA Microarray and Protein Data, Wiley, 2004.
Gabriel, The biplot graphics display of matrices with application to principal component analysis, Biometrika, 58:453-467, 1971.
Wouters et al., Graphical Exploration of Gene Expression Data: A Comparative Study of Three Multivariate Methods, Biometrics, 59, pp. 1131-1139, 2003.
Lewi, Spectral mapping, a technique for classifying biological activity profiles of chemical compounds, Arzneimittel Forschung (Drug Research), 26, pp. 1295-1300, 1976.
Diaz-Uriarte et al., Gene selection and classification of microarray data using random forest, BMC Bioinformatics, 7:3, 2006.
Itoh, Immunological aspects of diabetes mellitus: prospects for pharmacological modification, Pharmacol Ther., 44(3):351-406, 1989.
Pietropaolo et al., Cytoplasmic islet cell antibodies remain valuable in defining risk of progression to type 1 diabetes in subjects with other islet autoantibodies, Pediatr Diabetes, 6(4): 184-92, 2005.
Lokshin et al., Circulating IL-8 and anti-IL-8 autoantibody in patients with ovarian cancer, Gynecol Oncol., Jan. 21, 2006;
Lou et al., Strategies of biomarker discovery for drug development, Frontiers in Drug Design and Discovery, eds. Caldwell, D'Andrea, 2006.
Israeli et al., Anti-Saccharomyces cerevisiae and antineutrophil cytoplasmic antibodies as predictors of inflammatory bowel disease, Gut., 54(9): 1232-6, 2005.
Breiman, Random forests. Machine Learning, 45:5-32, 2001.
Lee et al., An extensive evaluation of recent classification tools applied to microarray data. Computational Statistics and Data Analysis, 48:869-885, 2005.
Tukey, J. W. (1951). Reminder sheets for “Discussion of paper on multiple comparisons by Henry Scheffé.” In The Collected Works of John W. Tukey VIII. Multiple Comparisons: 1948-1983 469-475. Chapman and Hall, New York.
Tukey, J. W. (1953). The problem of multiple comparisons. Unpublished manuscript. In The Collected Works of John W. Tukey VIII. Multiple Comparisons: 1948-1983 1-300. Chapman and Hall, New York.
Bertone et al., Advances in functional protein microarray technology, FEBS J., 272(21):5400-11, 2005.
Ilyin et al., Biomarker discovery and validation: technologies and integrative approaches, Trends Biotechnol., 22(8):411-6, 2004.
Lou et al., Strategies of biomarker discovery for drug development, Frontiers in Drug Design and Discovery, eds. Caldwell, D'Andrea, 2006.
Kusnezow et al., Antibody microarrays: promises and problems, Biotechniques, Suppl: 14-23, 2002.

1. A method for analyzing protein microarray data, comprising:
(a) preprocessing said protein microarray data;
(b) verifying that differences among distinct groups of proteins in said protein microarray data is observable in said protein microarray data;
(c) identifying distinct groups of proteins and features associated with said distinct groups; and
(d) corroborating the features identified.

2. The method of claim 1, wherein said preprocessing of said protein microarray data comprises:
(a) normalizing said protein microarray data;
(b) transforming said protein microarray data; and
(c) quality checking said protein microarray data.

3. The method of claim 2, wherein said normalizing of said protein microarray data comprises:
(a) creating a mock reference array (Mi) by taking the median across arrays: Mi=median (Xij); and
(b) normalizing all arrays to the mock reference array.
